(19) United States
(12) Patent Application Publication
(10) Pub. No.: US 2015/0286981 A1
(43) Pub. Date: Oct. 8, 2015

(54) SERVICE MONITORING DEVICE AND METHOD OF USE

(71) Applicant: Erik Bryan, Gilbert, AZ (US)

(72) Inventor: Erik Bryan, Gilbert, AZ (US)

(21) Appl. No.: 14/674,846

(22) Filed: Mar. 31, 2015

Related U.S. Application Data
(60) Provisional application No. 61/974,352, filed on Apr. 2, 2014.

(51) Int. Cl. G06Q 10/06; G06Q 10/00; H04W 4/00

(52) U.S. Cl. CPC G06Q 10/063114; H04W 4/005; G06Q 10/20

(57) ABSTRACT

A device and method of use for monitoring, supervising, and directing service technician activity (“STA”) is provided. The invention includes an apparatus and a process employing the apparatus. The apparatus includes a service technician component and a remote user component, which can be utilized simultaneously by one or more remote users to visualize the service field and interact in real time with the service technician. The process in combination with the apparatus provides a means for greatly enhanced involvement of one or more interested parties with the STA, regardless of the location and physical/environmental conditions at the site of the STA.

### CROSS REFERENCE TO RELATED APPLICATION

This application claims priority from U.S. Patent Application No. 61/974,352, filed Apr. 2, 2014 and entitled “Service Monitoring Device and Method of Use,” which is incorporated entirely herein by reference.

### BACKGROUND OF THE INVENTION

1. Technical Field

This invention relates to remote real-time monitoring of and interactivity with service technician activity (STA) along with ordering services and accessing technical support. Specifically, the invention relates to a portable system and method of use wherein a customer can share and participate in the experience of a service technician from a remote location, approve services and where the technician can access support services.

2. State of the Art

Service technicians (“STs”) are ubiquitous across a broad scope of industries, both residential and commercial, and play a necessary and invaluable role in today's modern society.

Customers, business owners, supervisors, and other interested parties require peace of mind with regard to STA. Customers need to understand details of the STA being performed. They need to be satisfied that STA is done correctly, and the nature and extent of the STA has been accurately communicated. Customers need a simple, reliable means to verify the work performed by a ST. An ideal way to gain insight into STA is to be “present,” in a virtual sense, and thus able to verify the condition of the item to be serviced and authorize the repairs or other work to be performed without being subject to unreasonable discomfort or dangerous conditions present at the site where the STA occurs. A system providing the means for a customer to be virtually present and able to give approvals should be easy to set-up and use.

Owners of businesses providing STA also have requirements, such as the need to ensure and demonstrate that STs are performing STA, and that STs bill customers competently, ethically, and honestly. To properly respond to customer complaints in a manner that extends beyond reviewing a limited written description of the service call by the ST, owners of businesses employing STs need an expanded means to do so. Owners and responsible managers need to investigate customer complaints and dissatisfaction in more detail that is available under the present state of the art.

Supervisors and other interested parties need to ensure the quality of the work, provide tech support in real time, supervise and train STs on the job, provide authorization for STA, and protect the reputation of their business and business brand.

These points underscore the need for a means by which a business owner, supervisor, customer, technical expert, or other interested party may accompany the ST performing STA, through the creation of a virtual multimedia experience, to the repair site. In order for service monitoring to become routine in residential and commercial settings, and to enhance its use for training and technical support purposes, an improved system is needed.

### SUMMARY OF EMBODIMENTS

As previously explained, the present invention relates to remote real-time monitoring of and interactivity with service technician activity (STA) along with ordering services and accessing technical support. Specifically, the invention relates to a portable system and method of use wherein a customer can share and participate in the experience of a service technician from a remote location; approve services and where the technician can access support services.

Embodiments of this invention disclose an integrated apparatus for use by one or more interested-party observers to remotely observe ST activity at the worksite, visualize the service field and communicate with the ST, archive the encounter, and direct third-party actions such as ordering parts and collecting payment for parts and services. The various embodiments of the invention also include a process by which one or more interested observers can direct and interact with the ST to monitor the service activity.

Disclosed is a service monitoring device comprising a remote user component comprising a first microprocessor a first memory comprising a first software package, a first power source, and a first wireless transmitter/receiver; a service technician component comprising a second microprocessor, a second memory comprising a second software package, a second power source, and a second wireless transmitter/receiver; and a communications link, wherein the first wireless transmitter/receiver of the remote user component and the second wireless transmitter/receiver of the service technician component are electronically coupled by the communications link.

In some embodiments, the remote user component further comprises a display. In some embodiments, the remote user component further comprises a first digital microphone. In some embodiments, the remote user component further comprises a first speaker. In some embodiments, the service technician component further comprises a display. In some embodiments, the service technician component further comprises a second digital microphone. In some embodiments, the service technician component further comprises a second speaker. In some embodiments, the service technician component further comprises a digital camera. In some embodimet6nsa, the service technician component further comprises a second display. In some embodiments, the service technician component further comprises a light source.

Disclosed is a method of using a service monitoring device comprising activating a remote user component; activating a service technician component; establishing a communication link; and demonstrating the condition of a service field to a remote user.

In some embodiments, the method further comprises a step receiving instructions from the remote user. In some embodiments, the method further comprises a step determining whether to access an additional remote user. In some embodiments, the method further comprises a step direction a service technician component digital camera at a service field. In some embodiments, the method further comprises a step performing repairs. In some embodiments, the method further comprises a step demonstrating the post-repair service field to the remote user.

Disclosed is a method of providing repair and maintenance service comprising scheduling a service call request from a customer for work at a customer location; attending to the call by going to the customer location; providing the customer with a first wireless tablet-like computer device having audio and video capability; synching said first wireless computer with a camera adapted to be used by a service technician, and transmitting a video feed from said camera to said first wireless computer.

In some embodiments, the method further comprises further streaming a real-time video to the customer through the wireless device during said service call whereby the cxustomer is able to view the service technician's work. In some embodiments, the method further comprises a step transmitting a repair order from a second wireless tablet-like computer from the service technician to the customer. In some embodiments, the method further comprises a step of the customer authorizing said repair order and a step sending said authorized repair order from said first computer to said second computer.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a schematic demonstrating the relationship between the components of a Service Monitoring Device;

FIG. 2 is a schematic depicting the relationship of the sub-components of a Remote User Component apparatus of a Service Monitoring Device;

FIG. 3 is a schematic depicting the relationship of the sub-components of a Service Technician Component apparatus of a Service Monitoring Device;

FIG. 4 is a flowchart diagramming a method 400 for service monitoring using a Service Monitoring Device; and

FIG. 5 is a flowchart diagramming a method 500 for service monitoring using a Service Monitoring Device.

### DETAILED DESCRIPTION OF EMBODIMENTS OF THE INVENTION

As noted above, STs perform work in a wide variety of residential and commercial settings. The residential activities of STs include the assessment, maintenance, and repair of machines used to keep a home habitable and comfortable, both inside and outside the structure. When the dishwasher leaks, the clothes dryer doesn't get the clothes dry, or the homeowner returns from vacation to find all of her frozen food has thawed and spoiled after the refrigerator-freezer stopped working, a ST is typically called to diagnose and repair the problem. Homeowners also rely on STs to troubleshoot and repair problems with utilities located outside the home, including air-conditioning compressors, lawn sprinkler and irrigation systems, septic tanks and sewers, conventional land-line telephone junction boxes, satellite television, and Internet-connectivity systems. Finally, problems often arise within the structural elements of the dwelling itself. Examples are rodent, termite, or other pest infestations; roof or plumbing leaks with resulting water damage, including the growth of toxic molds; and damage to the building's foundation, footings, or other structural support arising from various causes.

In industrial or commercial settings, STs are called to evaluate and repair an almost endless variety of machines; mechanical, electrical, and chemical systems; and the sometimes complicated building structures in commercial use.

It is critically important for the business owner employing STs to maintain quality control over the ST's work. The supervisor or owner of the business which employs the ST has some degree of responsibility for the ST's activities performed during the course of the ST's employment. Depending on the employment relationship, this responsibility may include a legal duty to take all reasonable measures to ensure the ST acts in a responsible manner while at the job site. The employer will incur liability for negligently performed assessments and repairs. Also, the business owner has a direct financial interest in the reputation of her business. For businesses that provide service through STs, the quality and consistency of work performed in the field define that business's brand and ultimate success or failure in a competitive market.

In each of these instances, and in others not discussed, the homeowner, resident, manager, or other relevant party has an interest in making sure the assessment is accurate, the diagnosis is reasonable, and the repair is properly performed. Ideally, the interested party would physically accompany the ST on location, visualize the damage, ask questions, and generally engage in dialogue with the ST. In this manner, the interested party can observe and interact with the ST in person. This interaction allows the party to ask questions while visualizing the problem or damage, and to observe the repair.

All too often, however, details surrounding both the damage and the activities of the ST remain a mystery to the supervisor and the contracting party. This is understandable. Even where a business owner, for example, may want to accompany the ST and “look over his shoulder,” there are innumerable reasons why this level of involvement is impractical, if not impossible. Along with a myriad of other obligations, business owners and their managers typically have supervisory responsibilities covering many individual STs. Even without other responsibilities, the supervisor cannot be in two places at once supervising two or more STs. Furthermore, the ST often works in an inhospitable and sometimes dangerous environment. During winter months, below zero temperatures and dangerous wind-chill may discourage or prevent a homeowner or business owner/manager from accompanying the ST who is working outdoors. Summer temperatures in the American Desert Southwest routinely exceed 110°, making activity outdoors or in a non-air conditioned indoor space dangerous for even the most fit and stoic persons. Although, presumably, the ST is trained, equipped, properly compensated, and accustomed to working in inhospitable environmental conditions, homeowners usually do not want to crawl in a narrow, dirty space under their house, or spend time in an under-ventilated attic.

The other situation requiring a party to “accompany” the ST to the site of STA arises when the ST needs advice, guidance, or instruction from a remotely located technical expert. The ST may need to share details of the damaged or malfunctioning structure with a supervisor or other technical expert to obtain real-time technical support or training. The technical expert will likely never be available at the work site, and might be thousands of miles away. The ST is, therefore, limited to talking with the technical expert over a cell phone, or at best to sending a small number of still images of the service field.

The present invention discloses an apparatus and process for remote real-time monitoring of STA. Generally, the apparatus comprises a remote user component and a service technician (ST) component. The method of using a service monitoring device involves monitoring service technician activity (STA) by one or more remote users via a communication link between the remote user(s) and the ST in real time. The remote user observes images collected and transmitted by the ST using the ST component through the remote user component. Some embodiments of the invention provide an interface for the remote user to interact with the ST in a variety of ways. The ST facilitates use of the invention by the remote user, in some embodiments, by directing a digital camera of the apparatus toward the area of interest (“service field”), thereby acquiring a digital image which the remote user may access and view in real time. The apparatus and process comprising some embodiments of the invention provide for three general functions: 1) real-time monitoring of STA by the remote user; 2) acquisition of a real-time image of the service field for transmission and visualization on a remote display by the remote user, including documenting and archiving the images and other data; and 3) interaction between the ST and the remote user in real time.

These three general functions are accomplished by use of the primary hardware and software components of the service monitoring device. As shown by the several drawing figures, a service monitoring device 100 comprising a remote user component 200, a service technician component 300, and a communications link 150.

It is understood in the descriptions contained herein that where “display,” “screen,” “monitor,” or other related term is used throughout this application, embodiments of the invention may use these or any type and number of displays for visualization of STA.

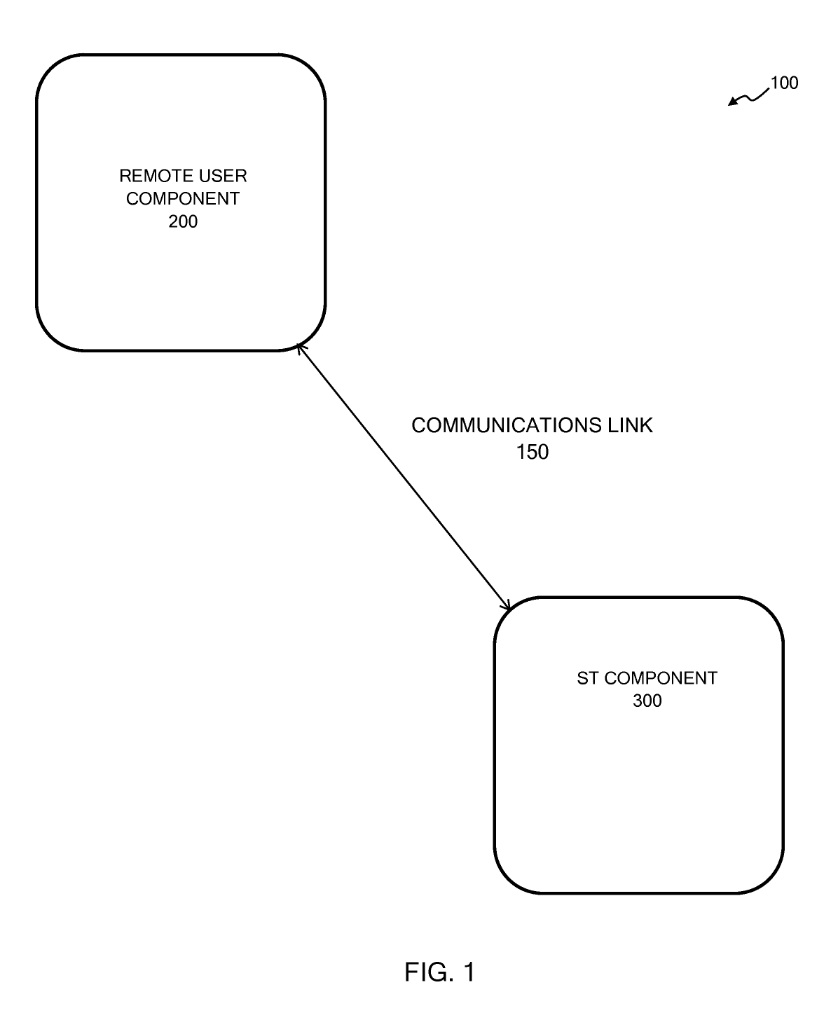

FIG. 1 depicts embodiments of service monitoring device 100, having remote user component 200 and service technician component 300. In some embodiments, remote user component 200 and service technician component 300 exchange data using a wireless communications link 150, as illustrated in FIG. 1. Wireless communications link 150, in some embodiments, is a cellular telephone signal relayed over a cellular communications network. In some embodiments, communications link 150 is a wireless local area network (“WLAN”). In some embodiments, communications link is an Ethernet connection to the Internet. The foregoing are offered as examples, and not meant to be limiting. Rather, communications link 150 is any means by which remote user component 200 and service technician component 300 may exchange data, including but not limited to audio and video, in real time over substantial distances.

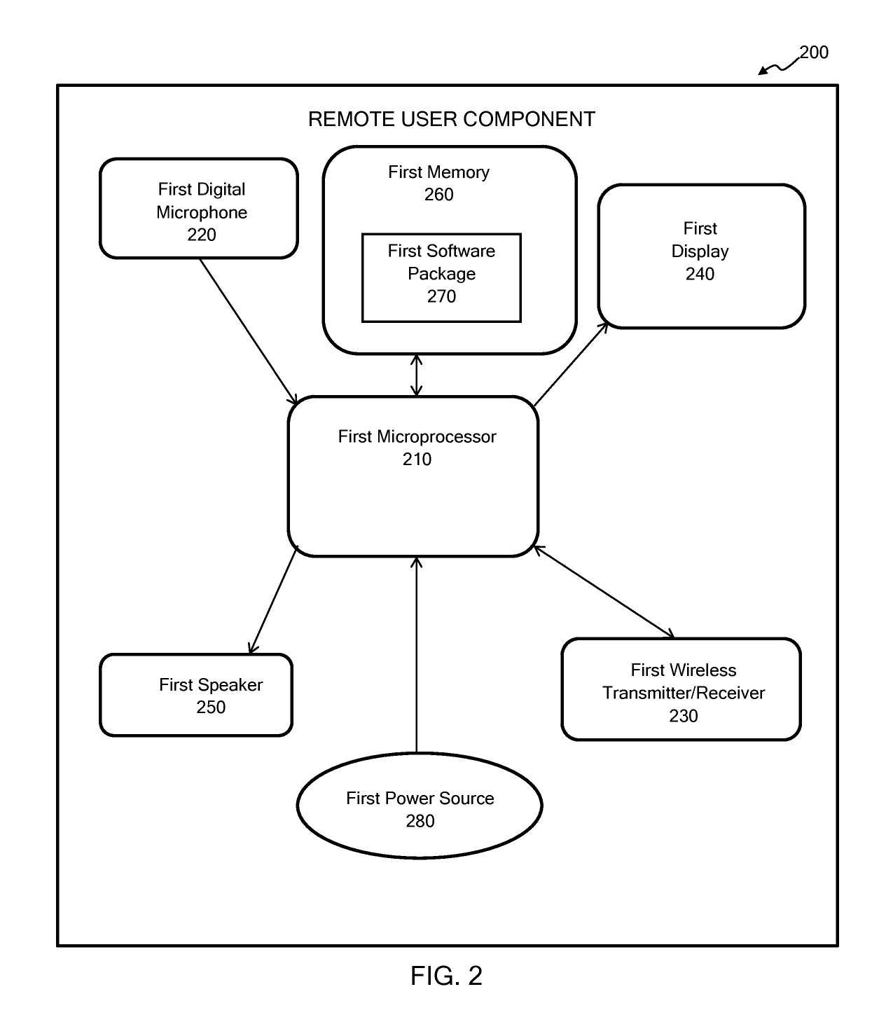

FIG. 2 depicts the remote user component 200 of service monitoring device 100. In some embodiments, remote user component 200 of device 100 comprises a first microprocessor 210, a first digital microphone 220, a first speaker 250, a first display 240, a first wireless transmitter/receiver 230, a first memory 260, and a first software package 270. In some embodiments, the remote user can control digital camera 340 and other features which may present in some embodiments of service technician component 300 of device 100. For example, when both remote user component 200 and service technician component 300 are activated, first wireless transmitter/receiver 230 receives a digital signal transmitted by second wireless transmitter/receiver 330 of service technician component 300. First wireless transmitter/receiver 230 is electrically coupled to first microprocessor 210. First microprocessor 210 is also electrically coupled to first display 240, the first speaker 250, a first digital microphone 220 and a first power source 280.

The digital signal from first wireless transmitter/receiver 230 is transmitted to first microprocessor 210 which translates the digital signal. First microprocessor 210 then relays the image portion of the digital signal to first display 240 for viewing by the remote user and relays the audio portion of the digital signal to first speaker 250 for listening by the remote user. First digital microphone 220 converts the remote user's speech to a digital signal for transmission to first microprocessor 210. First microprocessor 210 translates the resulting digital audio signal and transmits the audio output to first wireless transmitter/receiver 230 for transmission to service technician component 300 via communications link 150. Some embodiments of the invention comprise some or all of the components described in the foregoing example, although not all embodiments of the invention will necessarily comprise all of the listed components.

Some embodiments of the invention include first software package 270. First software package 270 is stored in first memory 260 and provides instructions executed by first microprocessor 210, allowing the remote user, through communications link 150 interface with service technician component 150, to perform and/or direct a variety of actions. Depending upon the particular embodiment of the invention, these actions, all directed by first software package 270, include but are not limited to accepting payment by electronic check or credit card, directing still or video photography, making adjustments (such as focus, lighting, contrast, field-of-view, and others) to digital camera 340; saving still photographs, video, or audio received by service technician component 200 to first memory 260; viewing current environmental conditions and weather data at service technician component 300's location; transmitting marketing and promotional materials to service technician component 300 for delivery to the customer; automatically uploading data to a server or other computer through first wireless transmitter/receiver 230, recording time spent by the ST performing inspection, repair, and other activities at the worksite, recording the geophysical location of the STA utilizing a satellite global positioning system (“GPS”), triangulation of cellular telephone signal towers, or other alternative technologies; and monitoring the STA of multiple STs simultaneously. Still other embodiments of the invention may feature additional functions enabled through additions to the first and second software packages.

Some embodiments of the invention utilize first display 240 contained within remote user component 200. Some embodiments utilize an external display at the remote user's location uploaded using first wireless transmitter/receiver 230. Any convenient external monitor device may be used in some of the various embodiments.

First digital microphone 220 and first digital speaker 250 are contained within the remote user component and are used to communicate with the ST via service technician component 300. Some embodiments of the invention comprise audio and/or video output jacks and may therefore utilize an external speaker, an external microphone, or both. In one example of such an embodiment, a supplemental digital microphone and speaker are contained within a headset worn by the remote user and electrically or wirelessly coupled to second microprocessor 310. Some embodiments of the invention utilizing an external speaker alone, an external microphone alone, or both an external speaker and external microphone together.

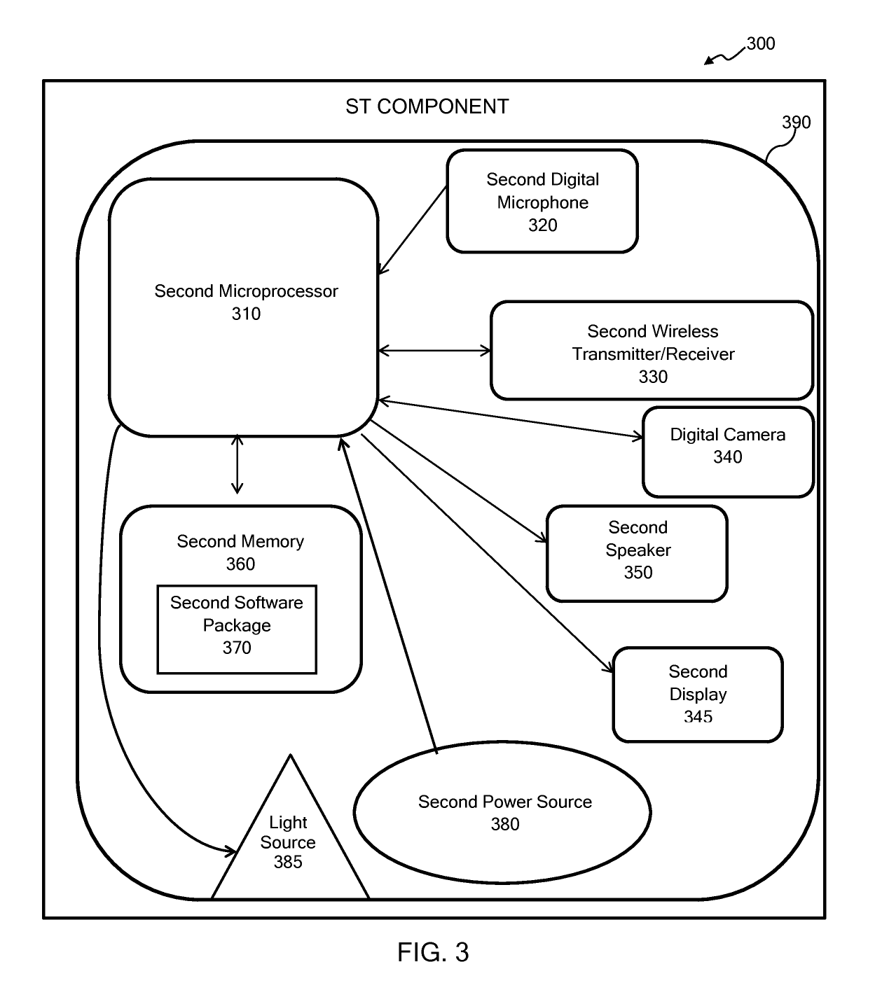

FIG. 3 depicts service technician component 300 of service monitoring device 100. Some embodiments of service technician component 300 comprise some or several additional elements, including a digital camera 340, a second microprocessor 310, a second memory 360, a second software package 370 for a remote user to control digital camera 340, and other features of service technician component 300 of service monitoring device 100, a second digital microphone 320, a second speaker 350, a second wireless transmitter/receiver 330, a second display 345, a light source 385, and a second power source 380.

In some embodiments, the aforementioned sub-components form an integrated service technician 300-unit, which is housed in a case 390 carried by the ST to the STA jobsite. Some embodiments of the invention include case 390 which is waterproof, water-resistant, shockproof, or shock-resistant. In many embodiments of the invention, case 390 and its subcomponents are lightweight and reasonably impervious to damage from heat, cold, moisture, shock, or dust/dirt/foreign particles such that service technician component 300 can be used in a wide range of environmental conditions. Some embodiments of the invention may utilize different cases, depending on the application and environmental conditions at the service site. Service technician component 300 of the apparatus can be made to be housed by different cases 390. In some embodiments of the invention, case 390 is interchangeable with alternative case(s) 390, according to the anticipated environmental and other conditions at planned locations of STA, depending upon the particular service industry. In some embodiments of the invention, service technician component 300 is permanently housed within case 390. Different embodiments use case 390 that is carried by the ST. Still other embodiments of the invention utilize a mounting system for case 390 of service technician component 300. The means for this system may, in some embodiments, comprise a harness made from nylon webbing or a similar material designed to be worn on the ST's torso or other area of the ST's person. In some embodiments, the mounting system is adapted to attach to a separate harness, helmet, head strap, or article of protective or other clothing otherwise worn by the ST but not specifically designed for use with the invention. Additional embodiments mount the camera to a fixed point near the service field but not on the person of the ST, such as a framing member, machinery housing, or other nearby fixed structure. There are a number of possible locations for detachably mounting service technician component 300. In these embodiments, service technician component 300 is either detachably or permanently coupled to the mounting apparatus. Some embodiments of service technician component 300 also include a mounting device to reversibly attach service technician component 300 to the body of a person or a nearby structure.

Digital camera 340, in some embodiments, is a digital camera that is generally lightweight, durable, and high-resolution. In some embodiments, digital camera 340 has a variable focal-length lens such that the remote user or the ST may adjust multiple parameters, including but not limited to the field of view, magnification, and recording of still or video images. Although in some embodiments, digital camera 340 is housed within case 390, some embodiments of the invention utilize digital camera 340 which is separate from case 390 and electrically or wirelessly coupled to second microprocessor 310, such as through a video input jack, for example. In some embodiments, digital camera 340 is worn by the ST as a headset. In some embodiments, digital camera 340 is mechanically coupled to a mounting system designed to be worn on the ST's torso or other areas of the ST's person. In still other embodiments, the mounting system is adapted to attach to a separate harness, helmet, head strap, or article of protective or other clothing otherwise worn by the ST but not specifically designed for use with the invention. In some embodiments camera 340 is mounted to a fixed point near the service field but not on the person of the ST, such as a framing member, machinery housing, or other nearby fixed structure. A number of possibilities exist for detachably mounting the digital camera 340 in a position whereby the camera may collect images of the service field.

FIG. 3 further depicts a second wireless transmitter/receiver 330 housed within case 390 of service technician component 300 for the direct wireless transmission of digital images and sound to remote user component 200 via communications link 150. In some embodiments, second receiver/transmitter 330 provides for streaming of images and video, with or without sound, to the Internet for access and viewing in real time via remote user component 200. Some embodiments may utilize a cellular signal transmitter and receiver for data transmission rather than a wireless Internet link. Cellular service is nearly ubiquitous, even in relatively undeveloped and rural areas, making this embodiment particularly useful.

Second memory 360 of service technician component 300 stores second software package 370, video data from digital camera 340, and audio data from second digital microphone 320. Data stored in second memory 360 may be retrieved for transmission to remote user component 200 during the service encounter, or may be archived for retrieval at a later time after the service visit has been completed. These data can be viewed and heard by the first display 240 and first speaker 250 of remote user component 200. Data stored in second memory 360 may also be uploaded to an external server, computer, or data storage device. Embodiments of the invention using first memory 260 to store data for later retrieval or upload are particularly useful to document all aspects of the STA, including the condition of any damaged or worn-out parts, and to demonstrate to the remote user that the ST performed STA in a non-negligent manner.

In some embodiments, such as the embodiment illustrated in FIG. 3, for example, second digital microphone 320 and second speaker 350 are contained within case 390. Other embodiments of the invention utilize an external speaker, digital microphone, or both. There are many such embodiments using an external speaker and digital microphone. One example is a headset worn by the ST. The external speaker and/or the external digital microphone may electrically connect to the ST component using a plug-in jack. Alternatively, an external speaker and/or external digital microphone may be wireless devices which connect using the second wireless transmitter/receiver 330 through and audio output and audio input jack respectively.

As shown in FIG. 3, some embodiments of the invention include a light source 385, such as a light emitting diode for example, integrated into service technician component 300 for illuminating the service field. When present in the embodiment, light source 385 may be controlled by second microprocessor 310, which provides power via second power source 380 when needed. In some embodiments, light source 385 is controlled by a switch, eight mechanical or solid-state, activated by a user of service technician component 300.

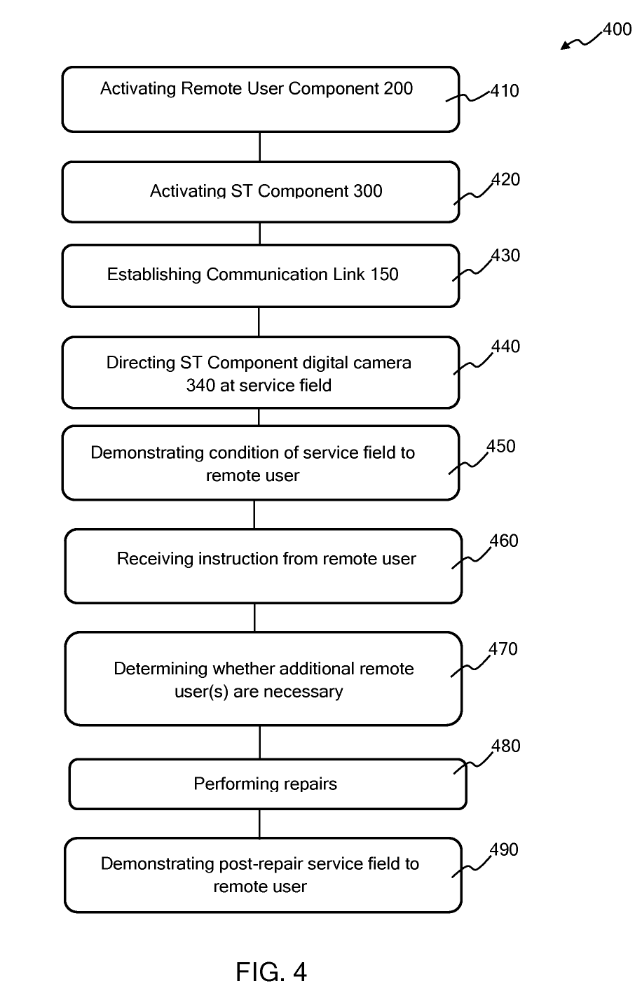

FIG. 4 illustrates steps of a method 400 for using the invention to monitor service activity. Generally and in some embodiments, method 400 comprises activating remote user component 200; activating service technician component 300, directing service technician component digital camera 340 as a service field; and demonstrating the condition of the service field to the remote user. In some embodiments of the invention, method 400 comprises one or more additional steps described herein below.

One or more remote users may utilize the invention to interact with and direct the activities of the ST using steps of method 400. Some examples of a remote user are the ST's supervisor, business owner, homeowner, landlord, or technical expert. Remote user component 200 can be provided to and activated by any interested remote user, depending on the particular application and setting, and the particular needs of the ST's employer.

Activating remote user component step 410 is performed by the remote user, wherein the remote user powers on remote user component 200. In some embodiments, activating step 410 comprises booting up first microprocessor 210 using first software package 270. In some embodiments, remote user component 200 may also use other external software packages similar to and compatible with second software package 370 of service technician component 300. Still other embodiments of the invention, activating step 410 comprises a performance check performed by the remote user on remote user component 200.

Similarly, some embodiments feature activating service technician component step 420 performed by the ST, wherein service technician component 300 is positioned at the location of the forthcoming STA and powered on. In some embodiments, activating service technician component step 420 includes booting-up using the second software package 370. In some embodiments, service technician component may utilize alternative or additional external software packages. Still other embodiments of the invention include the ST performing a systems performance check on the ST component 300 of the invention during activating service technician component step 420. In some embodiments, the remote user activates service technician component 300 via communications link 150.

Establishing communication link step 430 is accomplished by the ST and the remote user each, in some embodiments, establishing a communications link 150 between service technician component 300 and remote user component 200, as illustrated in FIG. 1. In some embodiments of the invention, establishing communication link step 430 is performed exclusively by the remote user. In other embodiments, the establishing communication step 430 is performed exclusively by the ST. As previously discussed, some embodiments use a cellular telephone network to establish communication link 150. Some embodiments of the invention may establish communication link 150 over the Internet. These examples of establishing communication link 150 step 130 are not meant to be limiting; any available means of wireless communication over medium to long distances may be utilized. Finally, in some embodiments of the invention wherein the remote user is a homeowner or officer or manager of a business at the location where the ST is performing the service, communication link 150 may be through a radiofrequency or other any other compatible means for wireless communication over relatively short distances; less than about 500 meters, for example.

The directing step 440 comprises the ST generally pointing digital camera 340 of service technician component 300 at the service field and acquiring a digital image of the service field. In some embodiments of the invention, the remote user may begin to control various adjustable parameters of digital camera 340 during this step. For example, the remote user may adjust the focus, field of view angle or magnification (zoom), and or other adjustable parameters of digital camera 340.

The demonstrating step 450, in come embodiments, comprises the ST demonstrating the condition of the service field to the remote user using transmission of digital video, still-digital photographs, and possibly digital audio to the remote user. During this step, the remote user and the ST communicate with each other. In some embodiments, the communication is via the first and second digital microphones 220 and 320; and the first and second speakers 250 and 350 of service monitoring device 100. In some embodiments, the remote user and the ST communicate with each other using standard cell phones not associated with service monitoring device 100. In some embodiments, the ST and the remote user communicate through a streaming digital link over the Internet. In some embodiments, the ST and/or remote user may store data using first memory 260, second memory 360, or utilize either service technician component 300 or remote user component 200 to upload a data file to an external server for access, directly or over the Internet, or other means by the customer or supervisor at a later convenient time of the user's choice.

In some embodiments, a receiving step 460 comprises the remote user directing the ST to take one or more actions and the ST receiving those directions. Some examples of possible directions received by the ST from the remote user include instructions to further examine specific portions of the service field, carry out the repair, or take some other action. Examples of other actions include authorizing the ST to contact a second remote user, such as a technical expert; order parts; collect; payment; etc.

In some embodiments, a determining step 470 addresses whether it is desirable or necessary to add one or more additional remote users. Determining step 470 is performed by the ST, the remote user(s), or both the ST and the remote user. Examples of additional remote users include but are not limited to the ST's supervisor or other owner/manager (where the customer is initially the sole remote user), or a technical expert such as a parts company representative or a trainer. In some embodiments, one or more steps may be added wherein a remote user may perform additional actions; for example, the remote user may order parts directly, initiate payment, and/or contact other remote users, if any. Some embodiments of method 400 include additional steps at this point, for example, the ST carrying out a standardized service checklist specific to the particular industry and device being serviced; saving still photographs, video, and audio data to second memory 360 of service technician component 300 and/or first memory 260 of remote user component 200; or other actions depending upon the features comprising first and second software packages 260 and 360. In still additional embodiments the ST receives training instructions, tips, and other information from a technical expert remote user during determining step 470. Receiving instructions or other information from a technical-expert-remote-user is distinguished from receiving instructions from a homeowner or other supervisory-remote-user to contacting a technical expert, who is not a remote user of the invention, by telephone or other means described earlier in this paragraph.

In some embodiments, a performing repairs step 480 comprises the ST completing the repairs. In some embodiments completing step 480 includes storing additional still photographs, video, audio, or other data in either first memory 260 or second memory 360, depending on the situation and the wishes of the remote user or ST; and collecting and recording payment by either the remote user or the ST. These examples of completing step are not meant to be limiting. Any action by the remote user or the ST necessary to complete the actual repairs and the service call in general are taken during this step.

In some embodiments, a demonstrating post-repair step 490 comprises the ST adjusting the service field image by moving the camera to demonstrate the post-repair condition of the service field to the remote user. The remote user, through remotely manipulating the digital camera and memory, may adjust the digital camera 340 image and collect additional video and audio data for observation or archiving in the first memory 360 during this step.

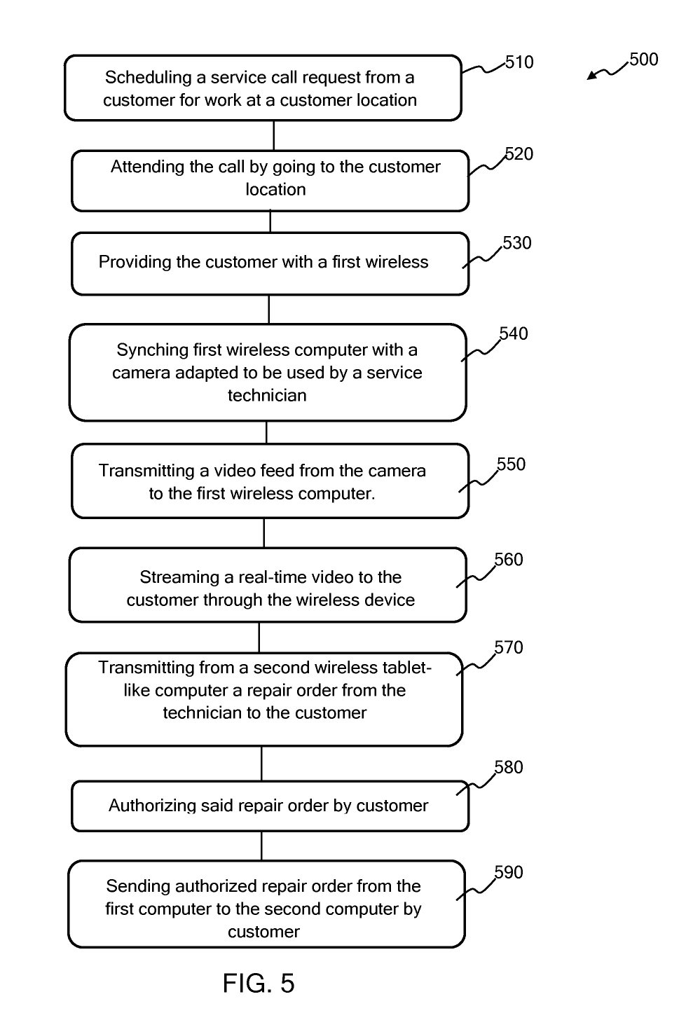

FIG. 5 illustrates steps of a method 500 for using the invention to monitor service activity. In some embodiments, method 500 comprises scheduling step 510, attending step 520, providing step 530, synching step 540, and transmitting step 550.

Scheduling step 510 comprises scheduling a service call for work at a customer location following a request from a customer. Some non-exclusive examples of this step occur wherein a customer, whether residential or commercial, contacts a service provider by telephone, Internet, or other appropriate means seeking to obtain service from a service technician. The service provider then schedules a time and location for the service call, based upon the customer's request and the availability of the service provider's service technicians.

Attending step 520 comprises a service technician, perhaps as assigned by the service provider, attending the scheduled service call by going to the customer's location.

Providing step 530 comprises provision of a first wireless tablet-like computer device having audio and video capability. In some embodiments, providing step 530 occurs following the service technician's arrival at the customer's location, wherein the service technician hands the first wireless tablet device to the customer. In some embodiments, the service technician provides instruction to the customer on the use of the first wireless tablet-like computer device during this step.

Synching step 540 comprises synching the first wireless computer with a camera adapted to be used by a service technician.

Transmitting step 550 comprises the service technician transmitting a video feed from the camera to the first wireless computer. In some embodiments, an additional streaming step 560 comprises streaming a real-time video to the customer through the wireless device. Synching step 540, with or without transmitting step 550, enables the customer's first wireless computer to receive video and, in some embodiments, audio feed from the service technician when the technician is evaluating the service field, performing repairs, and evaluating the completed repairs.

In some embodiments, method 500 further comprises a transmitting step 570, wherein the technician transmits from a second wireless tablet-like computer a repair order to the customer. In some embodiments, method 500 further comprises an authorizing step 580 wherein the customer authorizes the requested repairs. In some embodiments, method 500 further comprises a sending step 590, wherein the customer sends the authorized repair order from the first computer to the second computer. These steps, alone or in any combination in some embodiments, make it possible for the customer to immediately approve the desired repairs, communicate this approval to the technician from a remote location, and to create a digital record of the customer's approval. The service technician may then proceed with performing the repairs without leaving the repair site to communicate with the customer and obtain the necessary authorization from the customer.

This invention overcomes the aforementioned and other difficulties encountered with using prior art, such as physically accompanying the ST outdoors or into hazardous spaces indoors. It is designed to facilitate sharing real-time images of a ST's field of view, allowing for interaction between the ST and a remote observer. The widespread availability of real-time service field imaging will aid homeowners, business owners, ST supervisors and technical advisors working with STs to optimize the quality and efficiency of the ST's work. This invention broadens the availability of ST monitoring by interested persons in locations remote from the site of the STA with maximal safety and convenience for the remote observer.

In an example of the likely operation of service monitoring device 100 includes a company receiving a request for service from a customer and dispatching a ST to the customer. Upon arriving, the ST provides the customer with remote user component 200 of service monitoring device 100, activates both the component 300 and remote user component 200, and establishes communication link 150 between these two components. The ST may, at this time, also establish a communication link with one or more additional remote users, such as a supervisor or the service business owner. Alternatively, the supervisor or business owner may initiate a communications link 150 with service technician component 300. The ST then instructs the customer on the use of remote user component 200. If a routine inspection of the service field is planned, the ST can give the customer a written copy of an inspection checklist, standardized to the particular device requiring service. Alternatively, such a checklist may be loaded into remote user component 200 first memory 260. Once the ST confirms the customer understands the use and operation of remote user component, the ST goes to the device requiring service and undertakes necessary steps to expose the service field. With the service field now exposed, the ST may then direct digital camera 340 at the service field and demonstrate the condition of the service field to the customer and other remote users, if any. The ST may progress through the pre-established checklist, going over each step of the checklist point-by-point with the customer. Specific testing of individual components necessary to troubleshoot the problem with the device being serviced may also be performed at this time. The ST and/or the customer/other remote user(s) may elect to save still or video images throughout the checklist inspection to second memory 360 or first memory 260 to document details of the inspection and testing for later viewing. The inspection and testing being completed, the ST may present the customer with recommendations and receive authorization to proceed, or other instructions, from the customer and/or other remote user(s). Such other instructions may include customer authorization to order parts or obtain outside consultation with a technical expert. The ST then completes the repairs and demonstrates the post-repair service field the customer and any other remote user(s). The ST, customer, and any other remote user may elect to create photo/video documentation of the completed repairs at this time. Finally, with the repairs being completed to the customer's satisfaction, the ST prepares the final bill using service technician component 300 second software package 370 and transmits this to the customer, who in turn may utilize remote user component 200 to tender payment of the bill using an electronic check, debit, credit card payment, or other electronic means of payment.

Exceptional results can be obtained with the service monitoring device apparatus and process described in the various embodiments of the invention. The ST component apparatus is lightweight and durable, and produces high-resolution images. Wireless connection speeds are generally fast and reliable through cellular telephone transmitting/receiving towers. Thus, the disclosed method of use and various embodiments of the monitoring and recording system make possible the widespread, revolutionary use of virtual real-time service monitoring across many industries.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A service monitoring device comprising:
a remote user component comprising
a first microprocessor;
a first memory storing a first software package;
a first power source; and
a first wireless transmitter/receiver;
a service technician component comprising
a second microprocessor;
a second memory comprising a second software package;
a second power source; and
a second wireless transmitter/receiver; and
a communications link, wherein the first wireless transmitter/receiver of the remote user component and the second wireless transmitter/receiver of the service technician component are electronically coupled by the communications link, wherein:
the remote component provides real-time monitoring of service technician actions transmitted from the service technician component; the service technician acquires a real-time image of the service field for transmission and visualization on the remote display by the remote user component, including documenting and archiving the images and other data; and the remote user component and the service technician component provide interaction between a service technician and a remote user in real time.

2. The remote user component of claim 1, further comprising a display.

3. The remote user component of claim 1, further comprising a first digital microphone.

4. The remote user component of claim 1, further comprising a first speaker.

5. The service technician component of claim 1, further comprising a display.

6. The service technician component of claim 1, further comprising a second digital microphone.

7. The service technician component of claim 1, further comprising a second speaker.

8. The service technician component of claim 1, further comprising a digital camera.

9. The service technician component of claim 1, further comprising a second display.

10. The service technician component of claim 1, further comprising a light source.

11. A method of using a service monitoring device comprising:
activating a remote user component;
activating a service technician component;
establishing a communication link; and
demonstrating the condition of a service field from the service technician component to a remote user through the remote user component through the communication link.

12. The method of claim 11, further comprising receiving instructions from the remote user.

13. The method of claim 11, further comprising determining whether to access an additional remote user.

14. The method of claim 11, further comprising directing a service technician component digital camera at a service field.

15. The method of claim 11, further comprising performing repairs.

16. The method of claim 11, further comprising demonstrating the post-repair service field to the remote user.

17. A method of providing repair and maintenance service comprising:
scheduling a service call request from a customer for work at a customer location;
attending to the call by going to the customer location:
providing the customer with a first wireless tablet-like computer device having audio and video capability;
synching said first wireless computer with a camera adapted to be used by a service technician; and
transmitting a video feed from said camera to said first wireless computer.

18. The method of claim 17 further comprising:
streaming a real-time video to the customer through the wireless device during said service call whereby the customer is able to view the service technician's work.

19. The method of claim 18 further comprising transmitting from a second wireless tablet-like computer a repair order from the technician to the customer.

20. The method of claim 19 further comprising authorizing said repair order by the customer and sending said authorized repair order from said first computer to said second computer.
